(19) United States
(12) Patent Application Publication
(10) Pub. No.: US 2025/0365323 A1
(43) Pub. Date: Nov. 27, 2025

(54) SYSTEM AND METHOD FOR PROVIDING CONSOLIDATED TRAINING, HEARTBEAT VALIDATION AND ERROR MINIMIZATION APPROACH TO AI AGENTS

(71) Applicant: Affle (India) Limited, India, Gurugram (IN)

(72) Inventors: Anuj Khanna SOHUM, Singapore (SG); Charles Yong Jien FOONG, Templestowe (AU); Madhusudana RAMAKRISHNA, Singapore (SG)

(73) Assignee: Affle (India) Limited, India, Gurugram (IN)

(21) Appl. No.: 19/215,957

(22) Filed: May 22, 2025

(30) Foreign Application Priority Data
May 22, 2024 (IN) 202311079248

(51) Int. Cl. H04L 9/40; H04L 67/10

(52) U.S. Cl. CPC H04L 63/205; H04L 63/1425; H04L 67/10

(57) ABSTRACT

The present disclosure provides a system and method for managing an artificial intelligence (AI) agent within a secure cloud-based enclave. The system discloses consolidated training to optimize information retrieval by using a structured tree-like system, reducing redundancy in queries. The system provides heartbeat validation to evolve user preferences over time, ensuring accurate responses. Further, the system provides error minimization training to closely mimic user behavior, enhancing satisfaction. The system utilizes prompts and feedback to align responses with user intent. The system ensures that all involved agents are adequately trained, leading to more reliable outcomes. This integrated approach results in an efficient, adaptive, and reliable AI system, streamlining interactions and optimizing user experience.

### CROSS REFERENCE TO RELATED APPLICATIONS

This patent application claims priority to Indian Patent Application No. IN 202311079248, filed May 22, 2024, entitled “SYSTEM AND METHOD FOR PROVIDING CONSOLIDATED TRAINING, HEARTBEAT VALIDATION AND ERROR MINIMIZATION APPROACH TO AI AGENTS” and assigned to the assignee hereof. The disclosure of the prior application is considered part of and is incorporated by reference in this patent application.

### TECHNICAL FIELD

Embodiments of the present disclosure generally relate to artificial intelligence (AI) based systems and more particularly to system and method for providing consolidated training, heartbeat validation and error minimization approach to AI agents.

### BACKGROUND

In various fields of artificial intelligence and machine learning, training agents to perform specific tasks or learn complex behaviors is a fundamental and time-consuming process. Agents, such as neural networks, reinforcement learning models, and conversational AI systems, require extensive training to acquire the necessary skills and knowledge to be effective in their designated roles. However, the conventional training process often presents certain challenges, including the time required for comprehensive training and the need for secure knowledge sharing.

Training an agent, whether for natural language understanding, image recognition, or other domains, may be a time-consuming endeavor. The complexity of the tasks and the vast amount of data required for training may lead to extended training periods. Users, especially in real-world applications, may not have the patience or resources to dedicate to a single continuous training session. As a result, there is a growing need for a more flexible and progressive training mechanism that allows users to train their agents incrementally without the necessity of lengthy, uninterrupted training sessions.

Furthermore, in distributed environments where multiple agents may exist, it is crucial to avoid redundancy in training efforts. Duplicate training may lead to inefficiencies, resource wastage, and potential conflicts between agents.

Conventional AI agents have proven to be highly useful in answering queries, providing recommendations, and assisting with various tasks. However, the efficiency and effectiveness of AI agents heavily depend on the quality and depth of their training data.

Traditional AI training methods often involve extensive data collection and labeling, requiring substantial resources and time. Moreover, the accuracy of AI agents' responses is often limited by the information available within the training data. Users' interactions with AI agents frequently reveal an inherent challenge which is the need for tailored and efficient training.

Consequently, there is a need for improved system and method for providing consolidated training, heartbeat validation and error minimization approach to AI agents to address the aforementioned issues.

### OBJECTS OF THE INVENTION

Some of the objects of the present disclosure, which at least one embodiment herein satisfy, are listed herein below.

It is an object of the present subject matter to overcome the afore mentioned and other drawbacks existing in the prior art systems and methods.

It is a significant object of the present subject matter to design a system and method for managing the lifecycle of artificial intelligence (AI) agents using consolidated training, heartbeat validation, and error minimization techniques within a secure cloud-based enclave.

It is another object of the present subject matter to design a system and method that ensures efficient acquisition and refinement of AI agent knowledge using a context-aware, tree-structured information prompting mechanism with confidence scoring for inferred data.

It is yet another object of the present subject matter to provide continuous monitoring of AI agent behavior and preference alignment through deviation analysis and adaptive re-training or security triggering based on significance thresholds.

It is a further object of the present subject matter to reduce behavioral drift and inaccuracies in AI agent responses by incorporating user and coordinator feedback during error minimization training, and to propagate validated corrections across agent networks.

It is also an object of the present subject matter to securely handle user data, agent models, and training logs with end-to-end encryption, authenticated access control, and immutable audit logging to ensure privacy and trustworthiness within the AI ecosystem.

These and other objects and advantages of the present subject matter, will be apparent to a person skilled in the art after consideration of the following detailed description, taken into consideration with accompanied drawings in which preferred embodiments of the present subject matter are illustrated.

### SUMMARY OF THE INVENTION

Solution to one or more drawbacks of existing technology, and additional advantages are provided through the present subject matter. Additional features and advantages are realized through the technicalities of the present subject matter. Other embodiments and aspects of the subject matter are described in detail herein and are considered to be a part of the claimed subject matter.

In an embodiment, the present invention discloses a method for managing an artificial intelligence (AI) agent within a secure cloud-based enclave. The method includes operating, by the AI agent, as a primary interface to users or external systems and logs all operations of the AI agent for audit purpose, wherein the AI agent handles sensitive user data and learned models within the secure cloud-based enclave; executing at least one process selected from a consolidated training, a heartbeat validation and an error minimization training. The consolidated training includes identifying existing information and missing information, wherein the information includes user data or system knowledge associated with the AI agent; prompting the user for missing information using a tree-structured acquisition approach; inferring the missing information based on existing information and contextual inference; and determining a confidence score to each inferred missing information for assessing inference reliability. The heartbeat validation includes monitoring user preferences and behavioral pattern associated with the AI agent; computing a deviation based on a comparison of current user preferences with historical user preference data; evaluating the deviation against a predefined threshold to determine a significance level; and triggering at least one of: a re-training operation when the significance level within the acceptable range, or a security protocol operation when the significance level exceeds a predefined abnormality threshold. The error minimization training includes evaluating the behavior of AI agent based on outcome accuracy and user satisfaction metrics; prompting the AI agent to perform corrective behavioral adjustments for the AI agent; incorporating feedback from at least one of a user or a coordinator agent; and updating the behavior of the AI agent and propagating the correction across any other AI agents based on the feedback.

In an aspect, the method includes logging by the secure cloud-based enclave, all deviations, training activities, feedback responses, and behavioral updates in encrypted and immutable audit records. In an aspect, the method includes triggering clarification queries to the user by the heartbeat validation when the significance level is within a borderline range.

In an aspect, the method includes storing the confidence score computed during consolidated training, for use in future inference reliability assessments or re-training threshold decisions.

In an aspect, the method includes validating and approving, by the coordinator agent, proposed behavioral updates to the AI agent as generated by the error minimization training process. In an aspect, the method includes propagating, by the coordinator agent, the approved behavioral updates across a plurality of AI agents contributing to a common task context

In another aspect, the heartbeat validation, the consolidated training, and the error minimization training processes are executed cyclically to provide ongoing adaptation, security, and behavior correction for the AI agent.

In another embodiment, the present invention discloses a system for managing an artificial intelligence (AI) agent within a secure cloud-based enclave. The system includes one or more processors; and a memory storing programmed instructions executable by the one or more processors. The one or more processors execute the programmed instructions to: operate the AI agent as a primary interface to users or external systems and logs all operations of the AI agent for audit purpose, wherein the AI agent handles sensitive user data and learned models within the secure cloud-based enclave; execute at least one process selected from a consolidated training, a heartbeat validation, and an error minimization training, wherein: the consolidated training is configured to: identify existing information and missing information, wherein the information includes user data or system knowledge associated with the AI agent; prompt the user for the missing information using a tree-structured acquisition approach; infer the missing information based on existing information and contextual inference; and determine a confidence score for each inferred missing information to assess inference reliability; the heartbeat validation is configured to: monitor user preferences and behavioral patterns associated with the AI agent; compute a deviation based on a comparison of current user preferences with historical user preference data; evaluate the deviation against a predefined threshold to determine a significance level; and trigger at least one of: a re-training operation when the significance level falls within an acceptable range, or a security protocol operation when the significance level exceeds a predefined abnormality threshold; the error minimization training is configured to: evaluate the behavior of the AI agent based on outcome accuracy and user satisfaction metrics; prompt the AI agent to perform corrective behavioral adjustments for the AI agent; incorporate feedback from at least one of a user or a coordinator agent; and update the behavior of the AI agent and propagate the correction across other AI agents based on the feedback.

To further understand the characteristics and technical contents of the present subject matter, a description relating thereto will be made with reference to the accompanying drawings. However, the drawings are illustrative only but not used to limit the scope of the present subject matter.

Various objects, features, aspects, and advantages of the inventive subject matter will become more apparent from the following detailed description of preferred embodiments, along with the accompanying drawing figures in which numerals represent like components.

### BRIEF DESCRIPTION OF THE DRAWINGS

It is to be noted, however, that the appended drawings illustrate only typical embodiments of the present subject matter and are therefore not to be considered for limiting its scope, for the invention may admit to other equally effective embodiments. A detailed description is given with reference to the accompanying figures. In the figures, a reference number identifies the figure in which the reference number first appears. The same numbers are used throughout the figures to refer like features and components. Some embodiments of system or methods or structure in accordance with embodiments of the present subject matter are now described, by way of example, and with reference to the accompanying figures, in which

FIG. 1 illustrates an exemplary block diagram representation of a network architecture implementing a system and method for providing consolidated training, heartbeat validation and error minimization approach to AI agents, in accordance with an embodiment of the present disclosure;

FIG. 2 illustrates an exemplary block diagram representation of a computer implemented system, such as those shown in FIG. 1, capable of providing consolidated training, heartbeat validation and error minimization approach to AI agents, in accordance with an embodiment of the present disclosure;

FIG. 3 illustrates an exemplary flow diagram representation depicting process of providing consolidated training, heartbeat validation and error minimization training to AI agents, in accordance with an embodiment of the present disclosure; and

FIG. 4 illustrates an exemplary flow chart of a method for managing an artificial intelligence (AI) agent within a secure cloud-based enclave, in accordance with an embodiment of the present disclosure;

FIG. 4a illustrates an exemplary flow diagram representation depicting process of providing consolidated training, in accordance with an embodiment of the present disclosure;

FIG. 4b illustrates an exemplary flow diagram representation depicting process of providing heartbeat validation, in accordance with an embodiment of the present disclosure;

FIG. 4c illustrates an exemplary flow diagram representation depicting process of error minimization training, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

Embodiments of the present disclosure provide systems and methods for providing consolidated training, heartbeat validation and error minimization approach to AI agents. The present system enables AI agents to intelligently prompt users for specific details based on the available knowledge, significantly reducing redundant queries.

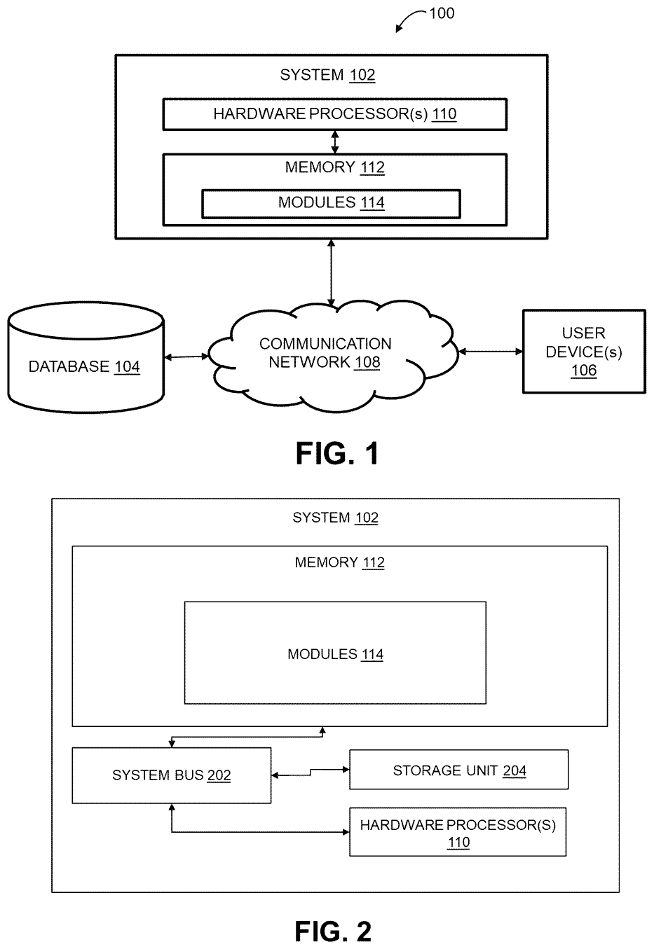

Referring now to the drawings, and more particularly to FIG. 1 through FIG. 4 and FIG. 4a-FIG. 4c, where similar reference characters denote corresponding features consistently throughout the figures, there are shown preferred embodiments, and these embodiments are described in the context of the following exemplary system and/or method.

FIG. 1 illustrates an exemplary block diagram representation of a network architecture 100 implementing a system 102 for system and method for providing consolidated training, heartbeat validation and error minimization approach to AI agents, in accordance with an embodiment of the present disclosure. According to FIG. 1, the network architecture 100 includes a system 102, a database 104, and one or more user devices 106. The one or more user devices 106 may be associated with one or more users, and communicatively coupled to the system 102 via a communication network 108. In an exemplary embodiment of the present disclosure, the user devices 106 may include a laptop computer, desktop computer, tablet computer, smartphone, wearable device, a digital camera, and the like. Further, the communication network 108 may be a wired network or a wireless network. The system 102 may be at least one of, but not limited to, a central server, a cloud server, a remote server, an electronic device, a portable device, and the like. Further, the system 102 may be communicatively coupled to the database 104, via the communication network 108. The database 104 may include, but is not limited to, personal data, health data, lifestyle data, any other data, and combinations thereof. The database 104 may be any kind of databases/repositories such as, but are not limited to, relational database, dedicated database, dynamic database, monetized database, scalable database, cloud database, distributed database, any other database, and combination thereof.

Further, the user device 106 may be associated with, but not limited to, a user, an individual, an administrator, a vendor, a technician, a worker, a specialist, a healthcare worker, an instructor, a supervisor, a team, an entity, an organization, a company, a facility, a bot, any other user, and combination thereof. The entities, the organization, and the facility may include, but are not limited to, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility and the like. The user device 106 may be used to provide input and/or receive output to/from the system 102, and/or to the database 104, respectively. The user device 106 may present to the user one or more user interfaces for the user to interact with the system 102 and/or to the database 104 for providing consolidated training, heartbeat validation and error minimization approach to AI agents. The user device 106 may be at least one of, an electrical, an electronic, an electromechanical, and a computing device. The user device 106 may include, but is not limited to, a mobile device, a smartphone, a personal digital assistant (PDA), a tablet computer, a phablet computer, a wearable computing device, a virtual reality/augmented reality (VR/AR) device, a laptop, a desktop, a server, and the like.

Further, the system 102 may be implemented by way of a single device or a combination of multiple devices that may be operatively connected or networked together. The system 102 may be implemented in hardware or a suitable combination of hardware and software. The system 102 includes one or more hardware processor(s) 110, and a memory 112. The memory 112 may include a plurality of modules 114. The system 102 may be a hardware device including the hardware processor 110 executing machine-readable program instructions for providing consolidated training, heartbeat validation and error minimization approach to AI agents. Execution of the machine-readable program instructions by the hardware processor 110 may enable the proposed system 102 to provide consolidated training, heartbeat validation and error minimization approach to AI agents. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more hardware processors 110 may include, for example, microprocessors, microcomputers, microcontrollers, digital signal processors, central processing units, state machines, logic circuits, and/or any devices that manipulate data or signals based on operational instructions. Among other capabilities, hardware processor 110 may fetch and execute computer-readable instructions in the memory 112 operationally coupled with the system 102 for performing tasks such as data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, routers, repeaters, firewall devices, network devices, databases, network attached storage devices, servers, assets, machinery, instruments, facility equipment, emergency management devices, image capturing devices, sensors, any other devices, and combination thereof. The person skilled in the art should not be limiting the components/subsystems shown in FIG. 1. Although FIG. 1 illustrates the system 102, and the user device 106 connected to the database 104, one skilled in the art may envision that the system 102, and the user device 106 may be connected to several user devices located at various locations and several databases via the communication network 108.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 102 as is unique to the present disclosure or necessary for an understanding of the present disclosure is depicted and described. The remainder of the construction and operation of the system 102 may conform to any of the various current implementations and practices that were known in the art.

In an exemplary embodiment, the system 102 may provide consolidated training, heartbeat validation and error minimization approach to AI agents.

In an exemplary embodiment, the system 102 may comprise a tree structure module responsible for organizing the acquisition of user information based on the available knowledge. This module prompts for specific details only when necessary.

Further, the system may further encompass an age-based inference engine. This engine is designed to determine the level of detail required for age-related information based on the data already provided by the user.

In an exemplary embodiment, the tree structure module also may include a date-based inference engine. This engine may be intelligently configured to prompt for additional date-related information depending on the extent of data already provided by the user.

In an exemplary embodiment, the system 102 may include an accuracy assessment module. This module is responsible for evaluating the reliability of data inferences made by the agents. Further, accuracy assessment module may include a confidence scoring mechanism. This mechanism assigns a confidence score to each inference, indicating the level of certainty associated with the inference.

In an exemplary embodiment, the system 102 may include a heartbeat validation system. The HV system introduces a dynamic preference assessment method, which involves monitoring shifts in user preferences over time. By comparing current preferences to historical data, the system 102 may determine the extent of deviation. If a significant deviation is detected, it triggers a re-training process to ensure that the AI aligns with the evolving preferences of the user.

In order to enhance AI performance, the system 102 may further incorporate a human input to validate the AI-generated responses. This validation process involves comparing the responses provided by humans with those generated by the AI, establishing confidence levels for each answer. This valuable feedback loop is then utilized to refine and improve the AI system, leading to more accurate and reliable outputs.

The system 102 may further also implement an adaptive AI training approach, integrating a feedback loop with human intervention to validate AI-generated outputs. Through the analysis of human-provided responses, the system 102 assesses the accuracy and confidence level of the AI. These validated responses are subsequently integrated into the training process, contributing to the ongoing refinement of the AI's capabilities.

To ensure a seamless user experience, the system 102 may employ a mechanism for scheduling additional user queries when necessary. This is determined by tracking the cumulative deviation of AI-generated responses from user preferences and setting a threshold for acceptable deviation levels. If the cumulative deviation exceeds this threshold, supplementary questions are automatically scheduled to gather further insights from the user. For example, scheduling additional user queries is achieved by tracking the cumulative deviation of AI-generated responses from user preferences and setting a threshold for acceptable deviation levels. Supplementary questions are triggered if the cumulative deviation surpasses the defined threshold, ensuring that users receive accurate and tailored responses from the AI system.

In an exemplary embodiment, the HV system operates on a foundation of continuous improvement, where it monitors user preferences and behavior patterns over time. By calculating the deviation between current preferences and historical data, the system 102 identifies areas for potential refinement. This may lead to the initiation of re-training or validation processes, ensuring that the AI remains aligned with the user's evolving preferences and needs. For instance, when deviations are detected, re-training or validation processes are initiated to adapt the AI's capabilities and maintain its relevance and accuracy.

In an exemplary embodiment, the system 102 provides a confidence-based AI training which involves employing human judgment to validate AI-generated responses and establishing confidence levels for each response based on human validation. These confidence scores are then used to inform re-training and refinement of AI models, leading to more reliable and accurate AI interactions.

The system 102 may act as a personalized AI interaction system which dynamically tracks changes in user preferences and tastes while verifying AI-generated responses through human validation. The validation results are used to adapt and optimize AI interactions for individual users, ensuring that the AI system caters to users' changing preferences over time.

In another exemplary embodiment, the system 102 provides a mechanism for error minimization training. This mechanism includes use of prompts to guide user interactions and elicit intended behaviors. Furthermore, the system 102 incorporates evaluation of user satisfaction levels with responses, enabling the fine-tuning of the model's behavior to more accurately mimic the user's desired actions.

In an exemplary embodiment, the system 102 is designed to replicate intended user behavior. The system 102 involves a feedback mechanism that rigorously assesses and validates the responses generated by the system 102. Additionally, the system 102 considers the input of other AI agents or coordinators in the decision-making process, ensuring a comprehensive approach to error minimization.

In an exemplary embodiment, the method of error minimization training involves a training process that extends to all agents involved in the decision-making pathway. This extensive training approach is aimed at guaranteeing that the model consistently delivers accurate and reliable results. The satisfaction levels of user responses are utilized as a key metric for continually improving the model's performance.

In a coordinator-based error minimization training system, coordinators are pivotal in the determination of model responses. However, the training process extends to encompass all agents participating in the decision-making path to ensure their synchronized behavior, thus minimizing errors in user behavior replication.

In an exemplary embodiment, the system 102 incorporates a network of agents working collaboratively to generate responses, making it a collective effort to ensure that intended user behaviors are faithfully reproduced. Training all agents involved in the decision-making process is integral to achieving a harmonized and error-minimized user experience.

A fundamental part of the error minimization training process is the use of prompts to guide user interactions and elicit specific desired outcomes. Furthermore, the responses generated are systematically validated through feedback mechanisms that involve both users and other agents within the system, thereby enhancing the overall quality of the user experience.

In an Error Minimization Training framework, a critical component is the mechanism for incorporating input from multiple agents in the response determination process. This framework entails training all agents along the decision path, which is essential for achieving a consistent and error-minimized user experience, ensuring that intended behaviors are faithfully replicated.

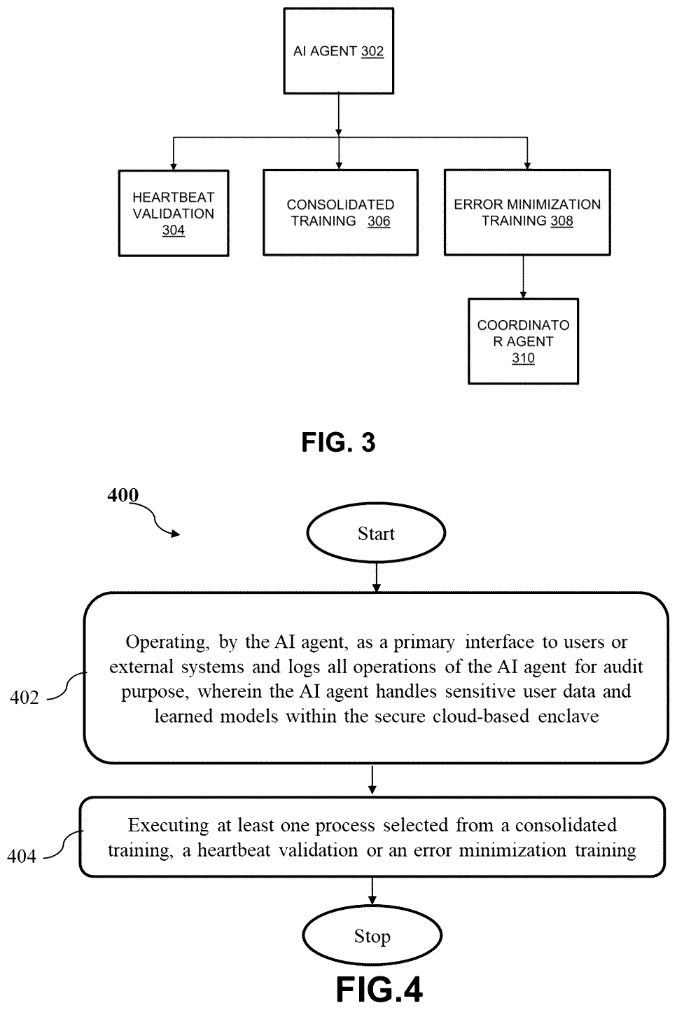

FIG. 2 illustrates an exemplary block diagram representation of a computer implemented system 102, such as those shown in FIG. 1, capable of providing system and method for providing consolidated training, heartbeat validation and error minimization approach to AI agents, in accordance with an embodiment of the present disclosure. The system 102 may also function as a computer-implemented system/server (hereinafter referred to as the system 102). The system 102 comprises the one or more hardware processors 110, the memory 112, and a storage unit 204. The one or more hardware processors 110, the memory 112, and the storage unit 204 are communicatively coupled through a system bus 202 or any similar mechanism. The memory 112 comprises a plurality of modules 114 in the form of programmable instructions executable by the one or more hardware processors 110.

The one or more hardware processors 110, as used herein, means any type of computational circuit, such as, but not limited to, a microprocessor unit, microcontroller, complex instruction set computing exceptionally long processor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory 112 may be a non-transitory volatile memory and a non-volatile memory. The memory 112 may be coupled to communicate with the one or more hardware processors 110, such as being a computer-readable storage medium. The one or more hardware processors 110 may execute machine-readable instructions and/or source code stored in the memory 112. A variety of machine-readable instructions may be stored in and accessed from the memory 112. The memory 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory 112 includes the plurality of modules 114 stored in the form of machine-readable instructions on any of the above-mentioned storage media and may be in communication with and executed by the one or more hardware processors 110.

The storage unit 204 may be a cloud storage or a repository such as those shown in FIG. 1. The storage unit 204 may store, but is not limited to, data points, personal information, trained datasets, human inputs, responses, confidence score, any other data, and combinations thereof. The storage unit 204 may be any kind of databases/repositories such as, but are not limited to, relational database, dedicated database, dynamic database, monetized database, scalable database, cloud database, distributed database, any other database, and combination thereof.

In an exemplary embodiment, the plurality of modules 114 may provide consolidated training to AI agents, perform heartbeat validation and error minimization training.

In an exemplary embodiment, the plurality of modules 114 may train AI agents, employing a tree structure for efficient information retrieval. This means that when prior knowledge exists, the plurality of modules 114 may intelligently formulate queries, prompting for only the missing information. For instance, if the age of an individual is known, the plurality of modules 114 will solely request the month and day. This innovative training strategy not only streamlines the training process but also minimizes redundancy, ensuring that users do not expend excessive time on training various AI agents.

In an exemplary embodiment, the consolidated training methodology encompasses a crucial accuracy assessment component. The plurality of modules 114 may evaluate the reliability of acquired data by incorporating probabilistic inference techniques. For instance, if a user's preference for Italian cuisine is known, there is a high probability they also enjoy pasta. However, the inference may only be partially accurate, leading to an assigned accuracy level, such as 50%. This accuracy metric serves as a valuable indicator of the system's confidence in its inferences.

In an exemplary embodiment, the plurality of modules 114 may perform heartbeat validation which introduces a dynamic approach to assessing user preferences over time. The plurality of modules 114 may involve periodic evaluations of user preferences, enabling the system 102 to adapt to changing tastes. This process entails soliciting human input for comparative analysis, serving as a benchmark for the AI's performance. By comparing the AI's responses to human input, the plurality of modules 114 may gauge if the AI could have answered correctly within a specified level of confidence. Should deviations over time exceed a predefined threshold, additional queries are scheduled for the user, ensuring the AI remains aligned with evolving preferences.

In an exemplary embodiment, the plurality of modules 114 may mirror the intended behavior of users by using an error minimization training method. This method adopts a multi-faceted approach. This method leverages user prompts, satisfaction feedback, and validation from other agents to refine AI responses and outcomes. This comprehensive training process aims to not only understand user intent but also to execute actions in a manner that closely aligns with user expectations. In situations where a coordinator or multiple agents contribute to decision-making, comprehensive training of all agents in the decision path is imperative. This ensures a harmonized response that effectively emulates the user's intended behavior, enhancing the overall effectiveness of the AI system 102.

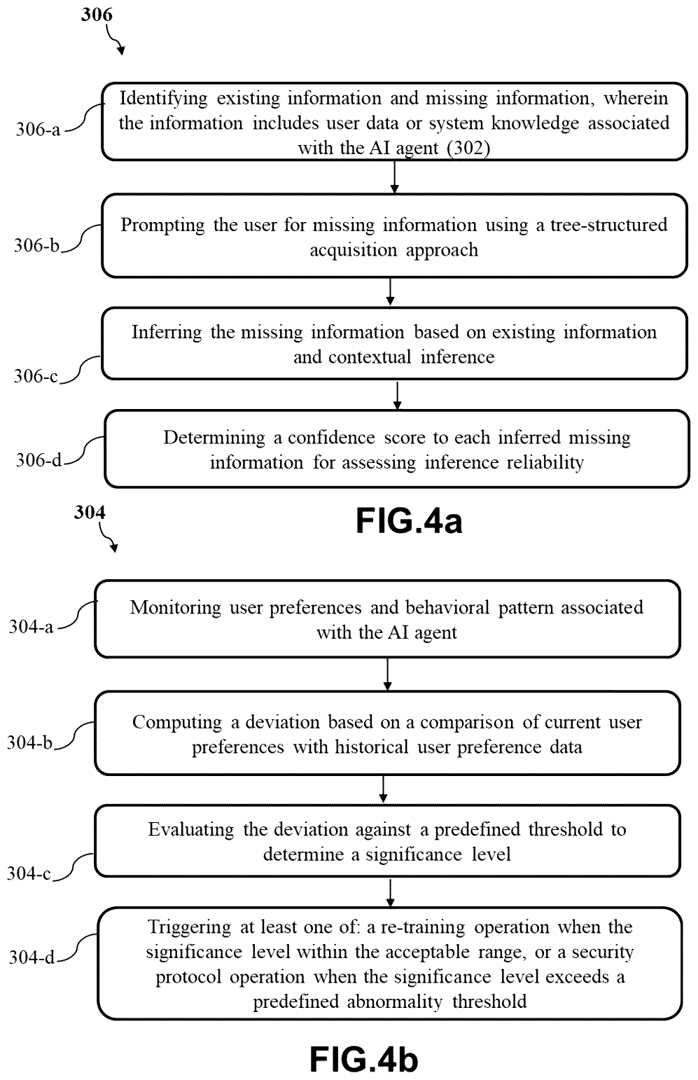

FIG. 3 illustrates an exemplary flow diagram representation depicting process of providing consolidated training, heartbeat validation and error minimization approach to AI agents, in accordance with an embodiment of the present disclosure. The system 102 employs a multifaceted approach to address the issue by heartbeat validation 304, consolidated training 306, and error minimization training 308.

In an exemplary embodiment, the consolidated training 306 addresses the limitations of current approaches by introducing a tree structure for information acquisition. The consolidated training 306 enables agents to intelligently prompt users for specific details based on the available knowledge, significantly reducing redundant queries.

For example, if the user has already provided the year of their birth, the consolidated training 306 prompts for the month and day, omitting the need to reiterate the year. Similarly, if the user has supplied the year and month, only the day is required, streamlining the data collection process. Moreover, the consolidated training 306 emphasizes the importance of accuracy in data inference. The consolidated training 306 incorporates a confidence scoring mechanism to quantify the reliability of inferences made by the AI agent. For instance, if the consolidated training 306 infers a preference for Italian food based on a liking for pasta, it assigns a confidence score, such as 50%, indicating the level of certainty associated with the inference.

In an exemplary embodiment, the heartbeat validation 304 is a process designed to monitor and adapt to changes in user preferences over time. Th heartbeat validation 304 recognizes that our preferences may evolve, necessitating periodic assessments to ascertain if re-training of the AI model is necessary. Instead of relying solely on the AI's judgment, human input is sought in this evaluation. A comparison is then made to determine if the AI's response aligns with human judgment within an acceptable level of confidence. This information serves as valuable feedback to refine the system and enhance its performance. In cases where the accumulated deviation surpasses a predefined threshold, the heartbeat validation 304 may proactively generate additional queries for the user, ensuring continued accuracy and relevance.

In an exemplary embodiment, error minimization training 308 employs prompts to guide user interactions and elicit intended behaviors, while also evaluating user satisfaction levels with responses for fine-tuning. The error minimization training 308. integrates a feedback mechanism to rigorously validate generated responses and considers input from coordinators 310 or other agents in the decision-making process. Training extends to all agents in the pathway to ensure consistent and accurate outcomes. This coordinated approach minimizes errors in replicating user behavior, ultimately enhancing the model's ability to mimic intended actions effectively.

In an exemplary embodiment, training of the data may also be shared through other agents, for example a VR headset agent could train your own behaviour through head, eye, body tracking to train your body language, dressing style, voice and engagement. The system could also track people around you like family members and also train models to ensure the greatest ease of training. Such systems will need a distributed permission-based system and ensure that data is only given to those that are approved.

In an exemplary embodiment, during such trainings, there may be an opportunity that other agents where there could be better models, this may also be part of a recommendation that could be incentivized.

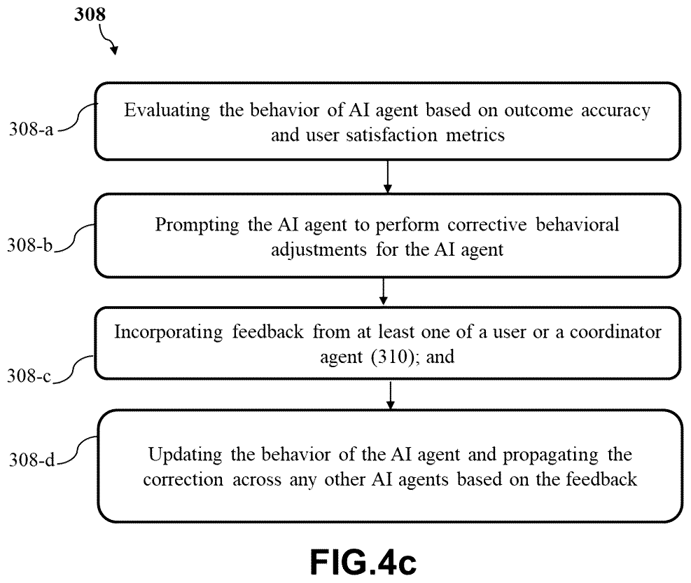

FIG. 4 illustrates an exemplary flow chart of a method for managing an artificial intelligence (AI) agent within a secure cloud-based enclave, in accordance with an embodiment of the present disclosure, whereas FIG. 4a, FIG. 4b and FIG. 4c illustrates an exemplary flow diagram representation depicting process of consolidated training, heartbeat validation and error minimization training respectively for AI agents. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 4, 4a, 4b, 4c may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved.

At block 402, the AI agent (302) is operated as a primary interface to users or external systems and logs all operations of the AI agent (302) for audit purpose, wherein the AI agent handles sensitive user data and learned models within the secure cloud-based enclave. At block 404, the secure cloud-based enclave executes at least one process selected from a consolidated training (306), a heartbeat validation (304) and an error minimization training (308) for the AI agent.

At block 306-a, the existing information and missing information are identified, wherein the information includes user data or system knowledge associated with the AI agent. At block 306-b, the users are prompted for missing information using a tree-structured acquisition approach. At block 306-c, missing information is inferred on existing information and contextual inference. The inference may be based on the response of the user for the prompt. At block 306-d a confidence score to each inferred missing information is determined for assessing inference reliability.

At block 304-a, user preferences and behavioral pattern associated with the AI agent is monitored. At block 306-b a deviation based on a comparison of current user preferences with historical user preference data is determined. At block 304-c, a significance level is evaluated form the deviation against a predefined threshold to determine. At block 304-d, a re-training operation is triggered when the significance level within the acceptable range, or a security protocol operation is triggered when the significance level exceeds a predefined abnormality threshold.

At block 308-a, behavior of AI agent is evaluated based on outcome accuracy and user satisfaction metrics. At block 308-b the AI agent is prompted to perform corrective behavioral adjustments for the AI agent. At block 308-c, feedback from at least one of a user or a coordinator agent (310) is incorporated. The coordinator agent (310) may operate as a supervisory entity configured to validate or refine behavioral updates. The coordinator agent (310) and may be a specialized AI model or a human-in-the-loop interface operating within the secure cloud-based enclave. At block 308-d the behavior of the AI agent is updated and further the validated correction across any other AI agents is propagated. The behavioral corrections across other AI agents is involved in a shared decision-making context to ensure harmonized and accurate outcomes.

The heartbeat validation process operates by monitoring user preferences and behavioral patterns on a continuous or periodic basis. This enables the system to capture both gradual and sudden changes in how the user interacts with the AI agent. The system stores historical behavioral data and uses it as a baseline to assess any shift in user behavior. To evaluate behavioral drift, the system calculates a deviation by comparing real-time user preferences with previously observed data. This deviation is compared against one or more predefined thresholds to assess significance level whether the change is within expected bounds or indicates an anomaly.

When the significance level falls within an acceptable range, it is typically treated as part of the natural evolution of user preferences. In such cases, the system may trigger a re-training operation or initiate additional validation processes to update the AI agent's behavior accordingly. However, when the deviation is determined to be abnormally large-such as a sudden reversal of established preferences—it may indicate potential issues such as model drift, data corruption, or unauthorized manipulation of the AI agent. In response, the system initiates security protocols, which may include flagging the agent for administrative review, isolating the agent from external interfaces, or requiring re-authentication.

To further enhance reliability, the system may optionally incorporate human oversight. Human reviewers may be invited through secure and authenticated channels to validate the AI agent's behavior or confirm the accuracy of its inferred understanding. This human input serves as a benchmark for preference alignment when the system detects ambiguous or borderline deviations.

In an embodiment, the error minimization training process leverages prompt-guided interactions to elicit the user's intended behavior or preferred outcome with high precision. These prompts are designed to clarify ambiguous responses and steer the AI agent toward accurately capturing user intent. The system evaluates not only the factual correctness of the AI agent's outputs but also user satisfaction, taking into account the contextual appropriateness and perceived usefulness of the agent's responses. To further improve accuracy and behavioral alignment, the system integrates multi-source feedback, including responses from the user and validation by a coordinator agent or other associated AI agents. This feedback loop allows the system to refine the AI agent's behavior continuously. In scenarios where multiple agents contribute to a shared decision-making pathway, the training process extends holistically across all such agents to ensure synchronized and consistent behavior. Ultimately, the objective of this training is to enable the AI agent to mimic the user's intended actions and interaction style with high fidelity, maintaining alignment over time.

The system enables integrated and interdependent execution of the consolidated training, heartbeat validation, and error minimization training modules in coordination with a central AI agent. Each module is dynamically invoked based on operational context—such as initiating consolidated training during onboarding, invoking heartbeat validation for ongoing preference monitoring, or executing error minimization in response to behavioral inaccuracies. The architecture follows a closed-loop design wherein outputs or triggers from one module may activate processes in another. For example, a deviation detected by the heartbeat validation process may trigger a re-training event that reuses the tree-structured logic of the consolidated training process. This intermodular feedback ensures continuous learning, adaptive behavior, and real-time correction of the AI agent within the secure cloud-based enclave.

In addition, when accumulated deviation surpasses a configurable threshold—even if individual deviations are not independently significant—the system proactively schedules clarification queries. These queries are designed to refine the agent's understanding and avoid misalignment with user expectations over time.

In an embodiment, the secure cloud-based enclave is configured to log all system activities, including deviations computed by the heartbeat validation process, training sessions initiated by the consolidated training process, feedback responses received during error minimization training, and behavioral updates to the AI agent. These logs are maintained as encrypted and immutable audit records, ensuring traceability, regulatory compliance, and system integrity within the secure enclave environment.

In another embodiment, the heartbeat validation process may trigger clarification queries to the user when the computed significance level of deviation falls within a borderline range. This enables proactive refinement of the AI agent's understanding before any erroneous adaptation or security flag is triggered, thereby preserving user alignment without false positives.

In a further embodiment, the system is configured to store the confidence scores computed during the consolidated training process. These confidence scores, associated with inferred information, are used in subsequent inference reliability assessments and to dynamically adjust thresholds for future training or re-training operations, thus improving training efficiency and knowledge quality.

In yet another embodiment, any proposed behavioral updates generated during the error minimization training process are validated and approved by a coordinator agent. The coordinator agent may operate as a specialized supervisory AI or a human-in-the-loop module within the secure cloud-based enclave and is configured to assess the quality and correctness of proposed behavioral changes prior to deployment.

Once validated, the coordinator agent may further propagate these approved behavioral updates across a plurality of AI agents that participate in a shared decision-making pathway. This ensures that updates are consistent and harmonized across the agent ecosystem, preventing contradictory behaviors among collaborative agents.

In an optional embodiment, the heartbeat validation process, consolidated training process, and error minimization training process are executed cyclically or event-driven, based on triggers such as behavioral drift, user dissatisfaction, or inference uncertainty. This cyclic execution enables the AI agent to undergo continuous adaptation, ensuring its long-term accuracy, reliability, and security within the secure cloud-based enclave.

Within a secure cloud-based enclave, the interactions between the AI agent, training modules, and the coordinator agent are implemented using secure Application Programming Interfaces (APIs) designed in accordance with security best practices. Each component must authenticate itself before initiating any communication or data exchange, and all operations are authorized based on the principle of least privilege, adhering to predefined roles and permissions configured within the enclave.

Each participating component—whether it is the AI agent, a training module, or the coordinator agent—is required to authenticate itself robustly prior to initiating any communication or data exchange. Access to operations and data is granted based on the principle of least privilege, with role-based access control and predefined permissions enforced uniformly within the enclave environment.

All communications within the enclave occur over strongly encrypted channels, such as those utilizing TLS 1.3 or higher, to ensure the confidentiality and integrity of data in transit. This prevents any unauthorized interception, tampering, or leakage of sensitive information exchanged between components during training, validation, or correction cycles.

In addition to securing data in transit, any data stored within the enclave—such as user profiles, AI model parameters, training datasets, historical preference data, and interaction logs—is encrypted at rest using industry-standard algorithms and key management systems. This ensures that even persistent storage remains protected against unauthorized access or compromise.

Data exchanged between components is serialized using secure, structured formats such as JSON or Protocol Buffers. These formats allow for efficient and reliable transmission while supporting strict schema validation and integrity checks during processing.

Furthermore, all critical events—such as data access requests, behavioral updates, security protocol activations, and alerts raised by the heartbeat validation process in response to anomalous deviations—are immutably logged within the enclave. These audit trails serve as a tamper-proof record for regulatory compliance, forensic analysis, and operational transparency.

The overall security framework is underpinned by the secure cloud-based enclave, which provides a trusted execution environment for all operations. This infrastructure ensures that all internal communications, behavior corrections, preference monitoring, and training activities are performed in a manner that meets the highest standards of privacy.

### Exemplary Consolidated Training, Heartbeat Validation and Error Minimization Approach:

Consider a scenario within an AI-powered mobile app designed for answering user queries and providing recommendations. In this scenario, a user, X, interacts with the AI-powered mobile app that assists with various aspects of daily life. User X has been using this platform for a while, and it has accumulated knowledge about personal details, preferences, and routines. The system 102 employs consolidated training, which leverages a tree-like structure for information retrieval. For instance, when user X wants to schedule an event, the system 102 intelligently prompts for specific details based on what it already knows. If the date and month are known, it asks for the day, optimizing the interaction.

As time passes, User X's preferences may shift. The system 102 employs heartbeat validation to stay in sync with User X's evolving tastes. Periodically, the system 102 engages User X in conversations about favorite activities, food choices, and entertainment options. The heartbeat validation 304 computes a deviation by comparing the current user preferences with historical preference data and evaluates the deviation against a predefined threshold to determine its significance level. If the significance level is within an acceptable range, the system 102 may trigger a re-training operation to update the AI agent's understanding accordingly. This feedback loop ensures that the system 102 adapts to User X's changing preferences, preventing any disconnect between the system's suggestions and User X's actual desires.

In certain implementations, the AI agent 302 may be configured to assist in sensitive domains such as personal finance management. In such scenarios, the ability to detect and respond to behavioral anomalies becomes critical for both user safety and system integrity. For example, when managing financial preferences and transactions, the heartbeat validation 304 plays a key role in identifying not only gradual preference shifts but also sudden and uncharacteristic deviations that may indicate risk, misuse, or potential compromise. When the heartbeat validation 304 detects a sudden, drastic, and uncharacteristic shift in User X's established financial behavior-such as an abrupt change in stated risk tolerance from “very conservative” to “extremely aggressive,” along with attempts to initiate large and unusual transactions that significantly deviate from historical patterns—this would be flagged as an anomalous deviation exceeding a predefined abnormality threshold. In such a scenario, the system 102, operating within the secure cloud-based enclave, would initiate appropriate security protocols as described elsewhere in this specification. These protocols may include, but are not limited to, temporarily suspending the AI agent's 302 ability to perform potentially harmful actions such as executing financial transactions, requiring immediate multi-factor re-authentication from User X before allowing further interaction, notifying designated security personnel or administrators through secure communication channels, and thoroughly logging the event and its context for forensic analysis. This illustrates the critical role of the heartbeat validation module not only in adapting to user preference shifts but also in maintaining the integrity and security of the AI agent 302.

Furthermore, the system 102 aims for error minimization in its responses. When User X seeks financial advice, the system 102 uses prompts to gather detailed information about goals and risk tolerance. The system 102 also considers feedback on previous recommendations to fine-tune its suggestions. In complex decisions involving multiple agents, the system 102 ensures that all parties down the decision-making path are adequately trained, guaranteeing a cohesive and reliable response.

Overall, this scenario exemplifies how the combination of consolidated training, heartbeat validation, and error minimization training contributes to an intelligent AI system 102 that not only efficiently acquires information but also dynamically adapts to user preferences and provides accurate, personalized assistance across various domains.

### Exemplary Scenario 1

Consider an exemplary scenario of an adaptive recommendation system. An e-commerce platform employs an adaptive recommendation system that suggests products based on user preferences. In this scenario, the system 102 uses heartbeat validation to periodically assess the accuracy of its recommendations. Specifically, the system 102 AI monitors user interactions and preferences over time. If a significant deviation is detected in user preferences, a validation process is triggered. The system 102 further prompts the user for feedback on recommended products. The user's feedback is compared against the AI's initial recommendation. If the AI's recommendation falls below a confidence threshold, it is flagged for potential retraining.

### Exemplary Scenario 2

Consider an exemplary scenario of a content personalization for streaming services. A streaming service uses AI to personalize content recommendations. The service implements Heartbeat Validation to ensure that user preferences are accurately captured. In this embodiment, the system 102 tracks user interactions, content choices, and feedback. When a deviation threshold is reached, the system 102 initiates a validation cycle. The user is asked to provide feedback on recommended content. The AI's suggestion is compared against the user's actual preference. If the confidence level is low, the system flags it for potential retraining.

### Exemplary Scenario 3

Consider an exemplary scenario of a virtual assistant for customer support. A virtual assistant is deployed for customer support, aiming to accurately mimic human-like interactions. Error Minimization Training is used to fine-tune the responses. In this embodiment, the system 102 responds to customer queries and monitors user satisfaction levels. The system 102 collects data on successful and unsuccessful interactions. A coordinator or secondary agents are involved in complex queries. The AI's responses and the satisfaction levels are analyzed for discrepancies. If errors persist, the entire decision-making process is reviewed and agents may undergo training.

For the sake of brevity, the construction, and operational features of the system 102 which are explained in detail above are not explained in detail herein. Particularly, computing machines such as but not limited to internal/external server clusters, quantum computers, desktops, laptops, smartphones, tablets, and wearables may be used to execute the system 102 or may include the structure of the hardware platform. As illustrated, the hardware platform may include additional components not shown, and some of the components described may be removed and/or modified. For example, a computer system with multiple GPUs may be located on external-cloud platforms including Amazon Web Services® (AWS), internal corporate cloud computing clusters, or organizational computing resources.

The hardware platform may be a computer system such as the system 102 that may be used with the embodiments described herein. The computer system may represent a computational platform that includes components that may be in a server or another computer system. The computer system may be executed by the processor (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor that executes software instructions or code stored on a non-transitory computer-readable storage medium to perform methods of the present disclosure. The software code includes, for example, instructions to gather data and analyze the data as the plurality of modules 114.

The instructions on the computer-readable storage medium are read and stored the instructions in storage or random-access memory (RAM). The storage may provide a space for keeping static data where at least some instructions could be stored for later execution. The stored instructions may be further compiled to generate other representations of the instructions and dynamically stored in the RAM such as RAM. The processor may read instructions from the RAM and perform actions as instructed.

The computer system may further include the output device to provide at least some of the results of the execution as output including, but not limited to, visual information to users, such as external agents. The output device may include a display on computing devices and virtual reality glasses. For example, the display may be a mobile phone screen or a laptop screen. GUIs and/or text may be presented as an output on the display screen. The computer system may further include an input device to provide a user or another device with mechanisms for entering data and/or otherwise interacting with the computer system. The input device may include, for example, a keyboard, a keypad, a mouse, or a touchscreen. Each of these output devices and input devices may be joined by one or more additional peripherals. For example, the output device may be used to display the results such as bot responses by the executable chatbot.

A network communicator may be provided to connect the computer system to a network and in turn to other devices connected to the network including other clients, servers, data stores, and interfaces, for example. A network communicator may include, for example, a network adapter such as a LAN adapter or a wireless adapter. The computer system may include a data source interface to access the data source.

The data source may be an information resource. As an example, a database of exceptions and rules may be provided as the data source. Moreover, knowledge repositories and curated data may be other examples of the data source.

Embodiments of the present disclosure provide systems and methods for providing consolidated training to AI agents. The present disclosure provides consolidated training that revolutionizes the way AI agents acquire information by introducing a tree-like structure. This innovative approach significantly streamlines interactions. For instance, if prior knowledge includes a person's age, the system 102 intelligently prompts for specific details like the month and day, eliminating redundant queries. This efficiency not only enhances user experience but also saves valuable time. Users no longer need to spend extensive periods training different AI agents separately. Consolidated training unifies the process, ensuring that users may swiftly adapt to and utilize various AI functionalities without the need for prolonged training sessions. Furthermore, this training method incorporates a data accuracy assessment mechanism. The present disclosure provides confidence levels in the accuracy of certain inferences, empowering users with insights into the reliability of the information provided.

Further, the present disclosure provides heartbeat validation mechanism to address the natural evolution of user preferences over time, a critical aspect in maintaining a dynamic and responsive AI system. By periodically checking in with users, the present disclosure ensures that its recommendations and responses remain aligned with current user preferences. This adaptive feature ensures a personalized and up-to-date experience, enhancing user satisfaction. The human-centric validation process is another distinctive advantage. Instead of relying solely on AI-generated responses, this method seeks human input, ensuring that user preferences are accurately captured. Any deviations may be promptly corrected through re-training, which ultimately leads to a higher level of system accuracy. Additionally, the system's 102 proactive approach in correcting deviations further solidifies its reliability. If the cumulative deviation from user preferences surpasses a predetermined threshold, the system 102 takes immediate action by scheduling additional queries. This forward-thinking strategy helps maintain a consistently high level of accuracy.

Further, the present disclosure provides error minimization training designed to ensure the accurate emulation of user behavior, a crucial aspect in delivering a satisfactory user experience. By utilizing prompts, gauging user satisfaction levels, and involving other agents in the decision-making process, the AI system 102 ensures that responses closely align with the user's intended actions. This leads to a more satisfactory and effective interaction. Additionally, this training method ensures coordinated decision-making in complex scenarios. In situations where a coordinator or multiple agents contribute to the response, this method ensures that all agents in the decision path are adequately trained. This coordinated effort results in more reliable and consistent outcomes, reducing the likelihood of errors or misunderstandings. These advantages contribute to creating a more effective, efficient, and reliable AI system that may adapt to user preferences, provide accurate responses, and minimize training time and effort.

The present disclosure further introduces a closed-loop architecture wherein the outputs or triggers from one module may dynamically initiate operations in another. For example, when the heartbeat validation process detects a significant deviation in user behavior, it may trigger a re-training process using the consolidated training module or initiate corrective action via the error minimization training module. This interconnected design ensures seamless transitions between monitoring, adaptation, and correction, thereby enabling continuous and autonomous lifecycle management of the AI agent.

In addition to adaptive learning, the heartbeat validation process also serves a critical security function. When the detected deviation exceeds a predefined abnormality threshold, the system interprets such deviations as potential indicators of AI agent compromise, unauthorized access, or data integrity issues. In such cases, the system may initiate security protocols such as isolating the AI agent, escalating alerts to administrative personnel, or requiring re-authentication, thereby safeguarding the integrity of the agent and the data it handles.

The error minimization training process is further augmented through the introduction of a coordinator agent. This agent operates either as a specialized supervisory AI or a human-in-the-loop component within the secure cloud-based enclave and is responsible for validating and approving proposed behavioral corrections to the AI agent. By integrating coordinator-level oversight, the system ensures that adjustments to the AI agent's behavior are not only based on user satisfaction but also benefit from broader context validation and quality assurance.

Moreover, the system extends error correction and training efforts across all AI agents involved in a shared decision-making context. Instead of confining corrections to a single AI agent, the system propagates validated behavioral updates across other agents contributing to the same outcome. This holistic training approach promotes synchronized and consistent agent behavior, which is especially valuable in complex multi-agent environments.

The confidence scores computed during the consolidated training process are stored and reused for future inference assessments. These scores serve as a measure of reliability for inferred data and may be used to adjust re-training thresholds dynamically. This allows the system to self-prioritize uncertain or low-confidence areas, thereby improving training efficiency and ensuring that future updates are targeted where they are most needed.

The written description describes the subject matter herein to enable any person skilled in the art to make and use the embodiments. The embodiments herein may comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium may be any apparatus that may comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

We claim:

1) A method for managing an artificial intelligence (AI) agent within a secure cloud-based enclave, the method comprising:
operating, by the AI agent, as a primary interface to users or external systems and logs all operations of the AI agent for audit purpose, wherein the AI agent handles sensitive user data and learned models within the secure cloud-based enclave;
executing at least one process selected from a consolidated training, a heartbeat validation and an error minimization training, wherein:
the consolidated training comprising:
identifying existing information and missing information, wherein the information includes user data or system knowledge associated with the AI agent;
prompting the user for missing information using a tree-structured acquisition approach;
inferring the missing information based on existing information and contextual inference; and determining a confidence score to each inferred missing information for assessing inference reliability;
the heartbeat validation, comprising:
monitoring user preferences and behavioral pattern associated with the AI agent;
computing a deviation based on a comparison of current user preferences with historical user preference data;
evaluating the deviation against a predefined threshold to determine a significance level; and
triggering at least one of: a re-training operation when the significance level within the acceptable range, or a security protocol operation when the significance level exceeds a predefined abnormality threshold;
the error minimization training, comprising:
evaluating the behavior of AI agent based on outcome accuracy and user satisfaction metrics;
prompting the AI agent to perform corrective behavioral adjustments for the AI agent;
incorporating feedback from at least one of a user or a coordinator agent wherein the coordinator agent operates as a supervisory entity configured to validate or refine behavioral updates; and
updating the behavior of the AI agent and propagating the validated behavioral correction across any other AI agents based on the feedback.

2) The method as claimed in claim 1, further comprising logging, by the secure cloud-based enclave, all deviations, training activities, feedback responses, and behavioral updates in encrypted and immutable audit records.

3) The method as claimed in claim 1, triggering clarification queries to the user by the heartbeat validation when the significance level is within a borderline range.

4) The method as claimed in claim 1, storing the confidence score computed during consolidated training, for use in future inference reliability assessments or re-training threshold decisions.

5) The method as claimed in claim 1, comprising validating and approving, by the coordinator agent, proposed behavioral updates to the AI agent as generated by the error minimization training.

6) The method as claimed in claim 5, comprising propagating, by the coordinator agent, the approved behavioral updates across a plurality of AI agents contributing to a common task context.

7) The method as claimed in claim 6, wherein the heartbeat validation, the consolidated training, and the error minimization training processes are executed cyclically to provide ongoing adaptation, security, and behavior correction for the AI agent.

8) A system for managing an artificial intelligence (AI) agent within a secure cloud-based enclave, the system comprising:
one or more processors; and
a memory storing programmed instructions executable by the one or more processors, wherein the one or more processors execute the programmed instructions to:
operate the AI agent as a primary interface to users or external systems and logs all operations of the AI agent for audit purpose, wherein the AI agent handles sensitive user data and learned models within the secure cloud-based enclave;
execute at least one process selected from a consolidated training, a heartbeat validation, and an error minimization training, wherein:
the consolidated training is configured to:
identify existing information and missing information, wherein the information includes user data or system knowledge associated with the AI agent;
prompt the user for the missing information using a tree-structured acquisition approach;
infer the missing information based on existing information and contextual inference; and
determine a confidence score for each inferred missing information to assess inference reliability;
the heartbeat validation is configured to:
monitor user preferences and behavioral patterns associated with the AI agent;
compute a deviation based on a comparison of current user preferences with historical user preference data;
evaluate the deviation against a predefined threshold to determine a significance level; and
trigger at least one of: a re-training operation when the significance level falls within an acceptable range, or a security protocol operation when the significance level exceeds a predefined abnormality threshold;
the error minimization training is configured to:
evaluate the behavior of AI agent based on outcome accuracy and user satisfaction metrics;
prompt the AI agent to perform corrective behavioral adjustments for the AI agent;
incorporate feedback from at least one of a user or a coordinator agent wherein the coordinator agent operates as a supervisory entity configured to validate or refine behavioral updates; and
update the behavior of the AI agent and propagating the validated behavioral correction across any other AI agents.

9) The system as claimed in claim 8, wherein the secure cloud-based enclave log all deviations, training activities, feedback responses, and behavioral updates in encrypted and immutable audit records.

10) The system as claimed in claim 8, wherein the heartbeat validation is further configured to trigger clarification queries to the user when the significance level of deviation is within a borderline range.

11) The system as claimed in claim 8, wherein the confidence scores computed during the consolidated training are stored for use in future inference reliability assessments or re-training threshold decisions.

12) The system as claimed in claim 8, wherein the coordinator agent is further configured to validate and approve the behavioral updates proposed for the AI agent by the error minimization training.

13) The system as claimed in claim 12, wherein the coordinator agent is further configured to propagate the approved behavioral updates across a plurality of AI agents contributing to a common task context.

14) The system as claimed in claim 8, wherein the heartbeat validation, the consolidated training, and the error minimization training are executed cyclically to provide ongoing adaptation, security, and behavior correction for the AI agent.

15) A non-transitory machine-readable medium including data, which when used by a system managing an artificial intelligence (AI) agent within a secure cloud-based enclave, causes the system to perform instructions that cause the system to perform operations comprising:
operating, by the AI agent, as a primary interface to users or external systems and logs all operations of the AI agent for audit purpose, wherein the AI agent handles sensitive user data and learned models within the secure cloud-based enclave;
executing at least one process selected from a consolidated training, a heartbeat validation and an error minimization training, wherein:
the consolidated training comprising:
identifying existing information and missing information, wherein the information includes user data or system knowledge associated with the AI agent;
prompting the user for missing information using a tree-structured acquisition approach;
inferring the missing information based on existing information and contextual inference; and determining a confidence score to each inferred missing information for assessing inference reliability;
the heartbeat validation, comprising:
monitoring user preferences and behavioral pattern associated with the AI agent;
computing a deviation based on a comparison of current user preferences with historical user preference data;
evaluating the deviation against a predefined threshold to determine a significance level; and
triggering at least one of: a re-training operation when the significance level within the acceptable range, or a security protocol operation when the significance level exceeds a predefined abnormality threshold;
the error minimization training, comprising:
evaluating the behavior of AI agent based on outcome accuracy and user satisfaction metrics;
prompting the AI agent to perform corrective behavioral adjustments for the AI agent;
incorporating feedback from at least one of a user or a coordinator agent wherein the coordinator agent operates as a supervisory entity configured to validate or refine behavioral updates; and
updating the behavior of the AI agent and propagating the validated behavioral correction across any other AI agents based on the feedback.
